(19) United States
(12) Patent Application Publication
(10) Pub. No.: US 2016/0026387 A1
(43) Pub. Date: Jan. 28, 2016

(54) Method of writing data in a solid state drive

(71) Applicant: Quanta Storage Inc., Taoyuan City (TW)

(72) Inventors: Cheng-Yi Lin, Taoyuan City (TW); Yi-Long Hsiao, Taoyuan City (TW)

(21) Appl. No.: 14/667,698

(22) Filed: Mar. 25, 2015

(30) Foreign Application Priority Data
Jul. 25, 2014 (CN) 201410359016.1

(51) Int. Cl. G06F 3/06; G06F 12/08; G06F 12/10

(52) U.S. Cl. CPC G06F 3/061; G06F 3/0659; G06F 3/0679; G06F 12/1009; G06F 12/0868; G06F 2212/608; G06F 2212/1016; G06F 2212/65

(57) ABSTRACT

A method of writing data in a solid state drive includes receiving data, converting the data to a logical page having a logical allocation address and logical allocation data, a first connection table is searched for another logical page the same as the logical page, the logical page is merged with the another logical page, the logical allocation address is temporarily stored in the first connection table, the logical allocation data is temporarily stored in the data cache unit, it is determined if the first connection table is filled, and the logical page temporarily stored in the cache memory is written to a corresponding flash memory to increase efficiency.

### BACKGROUND OF THE INVENTION

1. Field of the Invention

The present invention presents a method of writing data in a solid state drive, and more particularly, a method of writing data in a solid state drive by managing data in a cache memory, searching and modifying the data, and allocating the data to flash memories.

2. Description of the Prior Art

A solid state drive (SSD) conventionally has a number of NAND flash memories combined to form a storage device. The solid state drive has a fixed structure making it suitable to be carried around making transfer of data fast. Thus, the solid state drive is a popular product for transferring large amounts of data.

FIG. 1 illustrates a flowchart of a method of writing data in a solid state drive (SSD) according to prior art. The solid state drive of the prior art receives data having a logical block address (LBA) transmitted from a host and temporarily stores the data in a cache memory (step P1). The cache memory is searched for same data (step P2). Determine if there is same data (step P3). When there is same data, the same data and the data are merged (step P4). The data is converted to logical page data format having logical allocation address (LAA). The logical page is randomly allocated to a flash memory and registering the allocation in a mapping table (step P5). Individually transmitting the logical page to the flash memory through a first in first out method and writing the logical page in a memory page of a flash memory (step P6). Thus, the solid state drive of the prior art uses the data temporarily stored in the cache memory to search for the same data. And, the same data are merged with the data to reduce writing of repeated data to prevent high traffic in the transmission line of the flash memory causing the accessing of data to slow down and a delay the operations of the host.

Then, when the solid state drive of the prior art searches for the same data in the cache memory, all of the data temporarily stored in the cache memory has to be searched and compared which is very time consuming. In addition, the solid state drive of the prior art randomly allocates data to the flash memory. The cache memory is not able to accumulate more temporarily stored data. Thus, the chance to find same data during search is reduced. The data is also not equally distributed in the flash memories and there is a possibility of repeatedly writing data on the same flash memory of the solid state device. Since the number of times the flash memory can be accessed is limited, excessive concentration of use of a flash memory can occur and reduce the life span of the flash memory. Therefore, there are still problems to be solved in the method of writing data in the solid state drive of the prior art.

### SUMMARY OF THE INVENTION

An objective of the present invention is to present a method of writing data in a solid state drive. A first connection table corresponding to flash memories is established in a cache memory of the solid state drive to connect first parts of temporarily stored logical pages. The first parts are compared to search for same data to reduce the data to be compared and increase the speed of the search.

Another objective of the present invention is to present a method of writing data in a solid state drive. A data cache unit corresponding to flash memories is established in a cache memory of the solid state drive to statically and dynamically allocate the data to flash memories to equalize the life span of the flash memories.

A further objective of the present invention is to present a method of writing data in a solid state drive. A first connection table and a data cache unit are established in a cache memory to accumulate data of temporarily stored logical pages. When each logical plane address field is filled, temporarily stored logical pages are simultaneously written in corresponding flash memories to increase the efficiency of writing data and add the ability to search for same data.

To achieve the objective of the present invention, the method of writing data in the solid state drive comprises establishing a first connection table and a data cache unit in a cache memory of the solid state drive, receiving data from a host and converting the data to a logical page having a logical allocation address and logical allocation data, searching the first connection table for another logical page the same as the logical page, merging the logical page with the another logical page, temporarily storing the logical allocation address in the first connection table and temporarily storing the logical allocation data in the data cache unit, determining if the first connection table is filled, and writing the logical page temporarily stored in the cache memory to a corresponding flash memory.

The method of writing data in the solid state drive of the present invention establishes logical plane addresses in the first connection table to temporarily store logical allocation addresses of logical pages to connect logical allocation addresses of logical pages temporarily stored in the cache memory to form a comparison table.

Data cache fields corresponding to the logical plane address fields are established in data cache unit to temporarily store logical allocation data of the logical pages. Logical plane addresses each correspond to a flash memory of the solid state drive. Each logical plane address field corresponds to a memory level of a flash memory. Sequence of the logical plane address fields is set according to flash memories of the solid state drive and memory levels of the flash memories.

The method of writing data in the solid state drive of the present invention searching logical plane address fields of the first connection table for a logical allocation address of the another logical page the same as the logical page. When the first connection table does not have the another logical page same as the logical page, searching the first connection table for an empty logical plane address field and temporarily storing the logical page. When the first connection table is determined to be not filled, continue receiving data from the host. When at least one of logical plane address fields of each of logical plane addresses of the first connection table is determined to be filled, writing the logical page temporarily stored in the cache memory to a corresponding flash memory. Or, when at least one of logical plane address fields of each of logical plane addresses is determined to be filled, simultaneously writing each logical page registered in the logical plane addresses to a corresponding flash memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a method of writing data in a solid state drive (SSD) according to prior art.

FIG. 2 illustrates a structure of a solid state drive (SSD) according to an embodiment of the present invention.

FIG. 3 illustrates a format of data of a logical page according to an embodiment of the present invention.

FIG. 4 illustrates a structure of a first connection table according to an embodiment of the present invention.

FIG. 5 illustrates a structure of a data cache unit according to an embodiment of the present invention.

FIG. 6 illustrates a diagram of writing data into the solid state drive according an embodiment of the present invention.

FIG. 7 illustrates a flowchart of a method of writing data in a solid state drive according to an embodiment of the present invention.

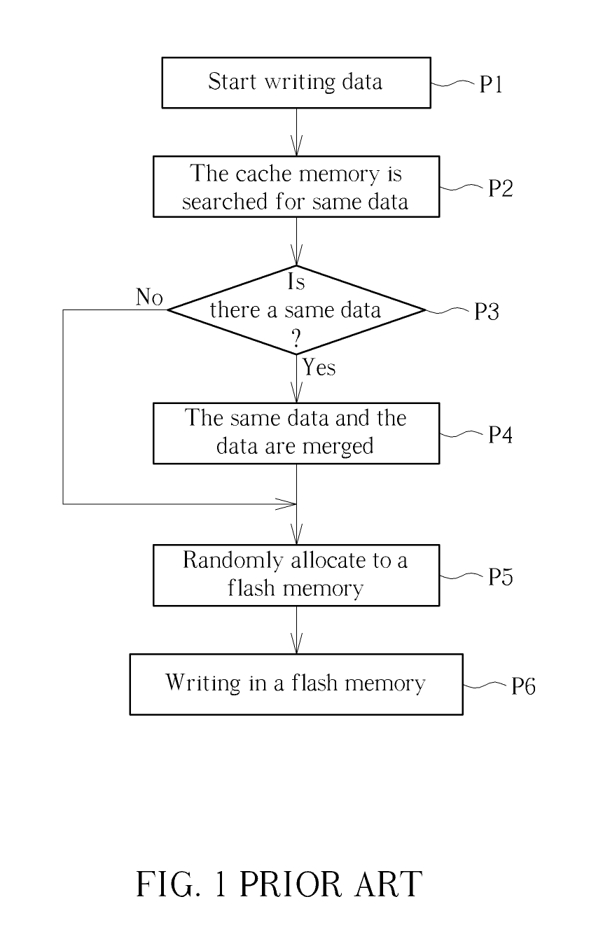

### DETAILED DESCRIPTION

To achieve the objective of the present invention, preferred embodiments of the present invention are described in the following paragraphs together with some illustrations.

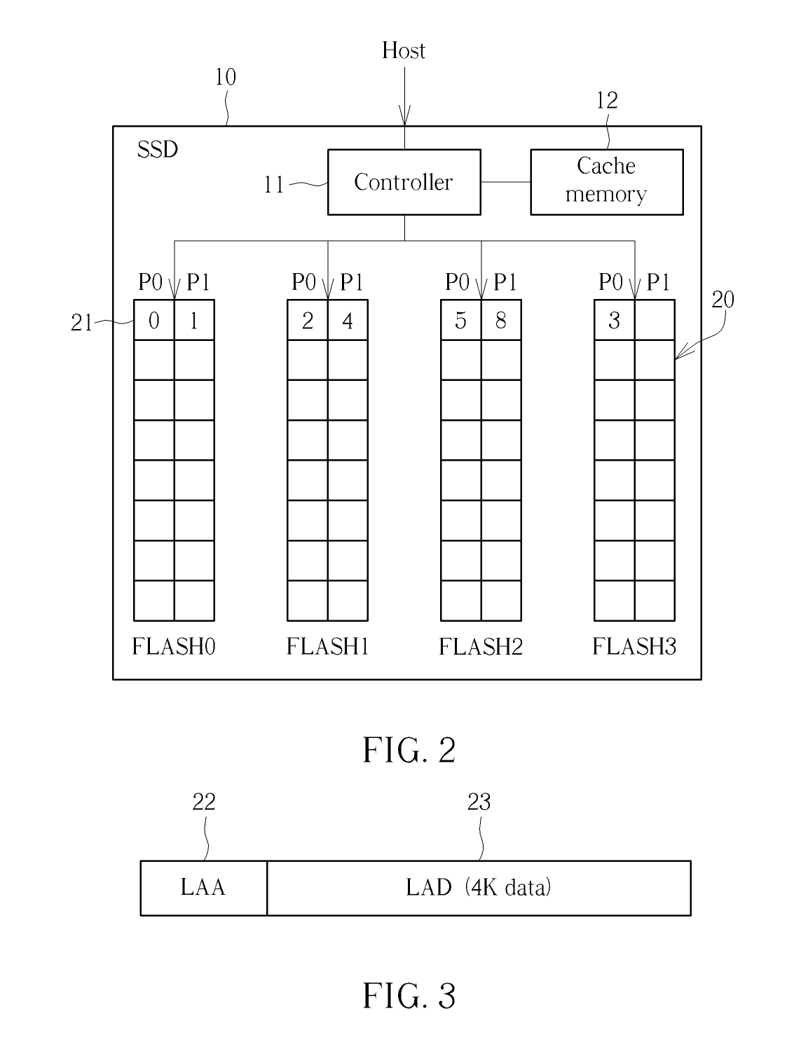

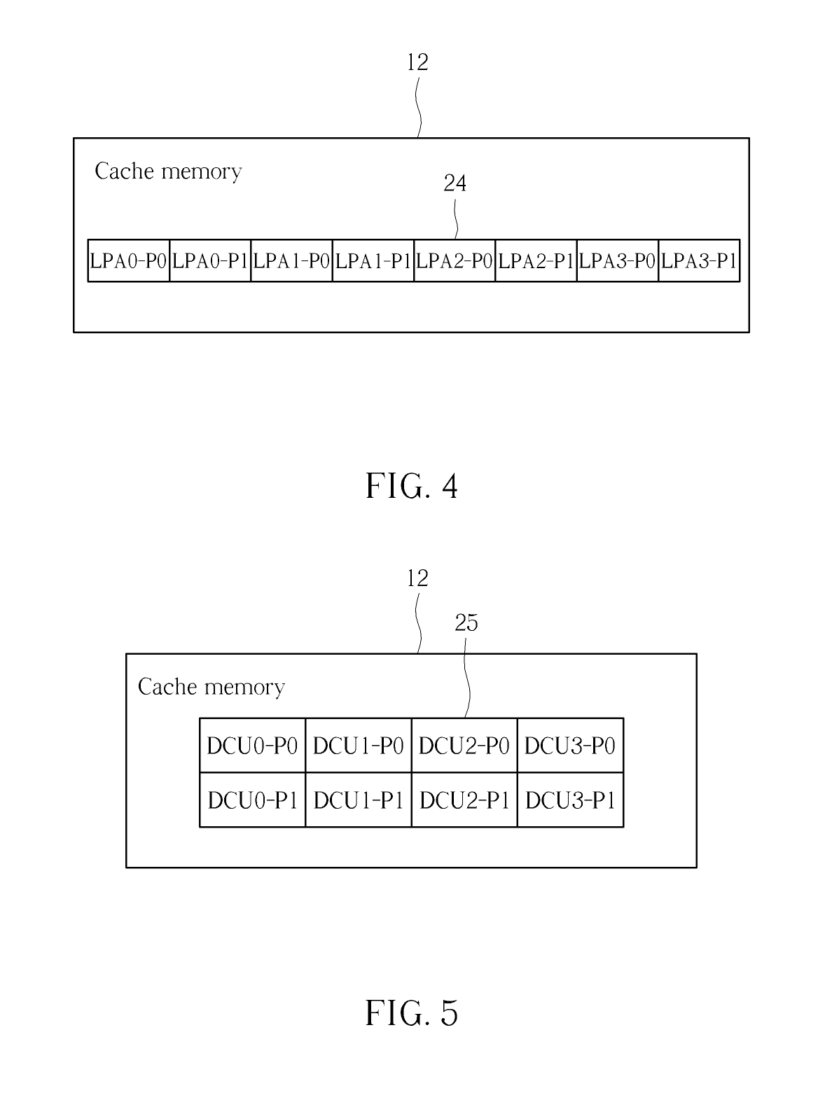

FIG. 2 illustrates a structure of a solid state drive (SSD) 10 according to an embodiment of the present invention. FIG. 3 illustrates a format of data of a logical page according to an embodiment of the present invention. FIG. 4 illustrates a structure of a first connection table 24 according to an embodiment of the present invention. FIG. 5 illustrates a structure of a data cache unit 25 according to an embodiment of the present invention. The solid state drive 10 in FIG. 2 may comprise a controller 11, a cache memory 12, and a plurality of flash memories 20. The controller 11 may be used together with the cache memory 12 to receive data from the host and control accessing of data of the plurality of flash memories 20. The cache memory 12 may be used to temporarily store data. The number of the plurality of flash memories 20 of the solid state drive 10 may vary depending on the size of the solid state drive 10. Although the embodiment of the solid state drive 10 only has four flash memories FLASH0 to FLASH3, the present invention is not limited to only having four flash memories.

The number of bits the flash memory 20 may store may depend on the type of cell of the flash memory 20. The flash memory 20 may be a single level cell (SLC), a multi-level cell (MLC), a triple level cell (TLC), or a quad level cell (QLC) etc. The flash memory 20 of the described embodiment may be a multi-level cell. Although the embodiment of the present invention may be using the multi-level cell in further description, but the present invention is not limited to using a multi-level cell flash memory. The multi-level cell flash memory 20 may comprise a lower memory level PO and an upper memory level P1. Each memory level may be set to have a plurality of physical pages used to store data of a logical page. The multi-level cell flash memory 20 may connect the physical pages of the lower memory level PO and the upper memory level P1 to be able to simultaneously access the data of the logical pages.

When the solid state drive 10 of the present invention receives a logical block address (LBA) of data to be written from the host, as shown in FIG. 3, the data may be converted to a logical page having a data format with a logical allocation address (LAA) for the first part 22 and a logical allocation data (LAD) for the data part 23. The logical allocation address may be the address of the logic page in the solid state drive 10 and the logical allocation data may be the data stored by the user. The logical page may be temporarily stored in the cache memory 12 to wait to be written in the flash memory 20. The logical allocation address of the logical page may correspond to the logical block address of the data. The solid state drive 10 may use a mapping table to observe interconnections.

To manage the logical pages temporarily stored in the cache memory 12, as shown in FIG. 4, the first connection table 24 may be established in the cache memory 12. Logical plane addresses (LPA) LPA0 to LPA3 may be set in the first connection table 24 and may respectively correspond to first flash memory FLASH0 to fourth flash memory FLASH3. Each logical plane address may be set to have a lower logical plane address field and an upper logical plane address field to correspond to respectively the lower memory level P0 and the upper memory level P1 of each flash memory 20. The logical plane addresses LPA0 to LPA3 may be used to store the logical allocation address of the logical page waiting to be written. For example, the lower logical plane address field LPA0-P0 of the logical plane address LPA0 may temporarily store the logical allocation address of the logical page waiting to be written in the lower memory level P0 of the first flash memory FLASH0. The logical plane address field may be written in sequence according to the lower memory level PO and the upper memory level P1 of the first flash memory FLASH0 to the fourth flash memory FLASH3. The first connection table 24 may be used to connect logical allocation addresses of logical pages temporarily stored in the cache memory to form a comparison table. Similarly, the data cache unit 25 shown in FIG.5 may be formed in the cache memory 12. A data cache field corresponding to the lower memory level PO and the upper memory level P1 of the first flash memory FLASH0 to the fourth flash memory FLASH3 may be set in the data cache unit 25. Each of the data cache field may correspond to a logical plane address field and may be used to temporarily store logical allocation data of a logical page waiting to be written. For example, the data cache field DCU1-P1 may be used to temporarily store the logical allocation data of the logical page waiting to be written in the upper memory level P1 of the second flash memory FLASH1. The data cache fields may be sequenced according to the sequence of the logical plane address fields. The data cache unit 25 may separately store the logical allocation data from the logical allocation addresses of the temporarily stored logical pages.

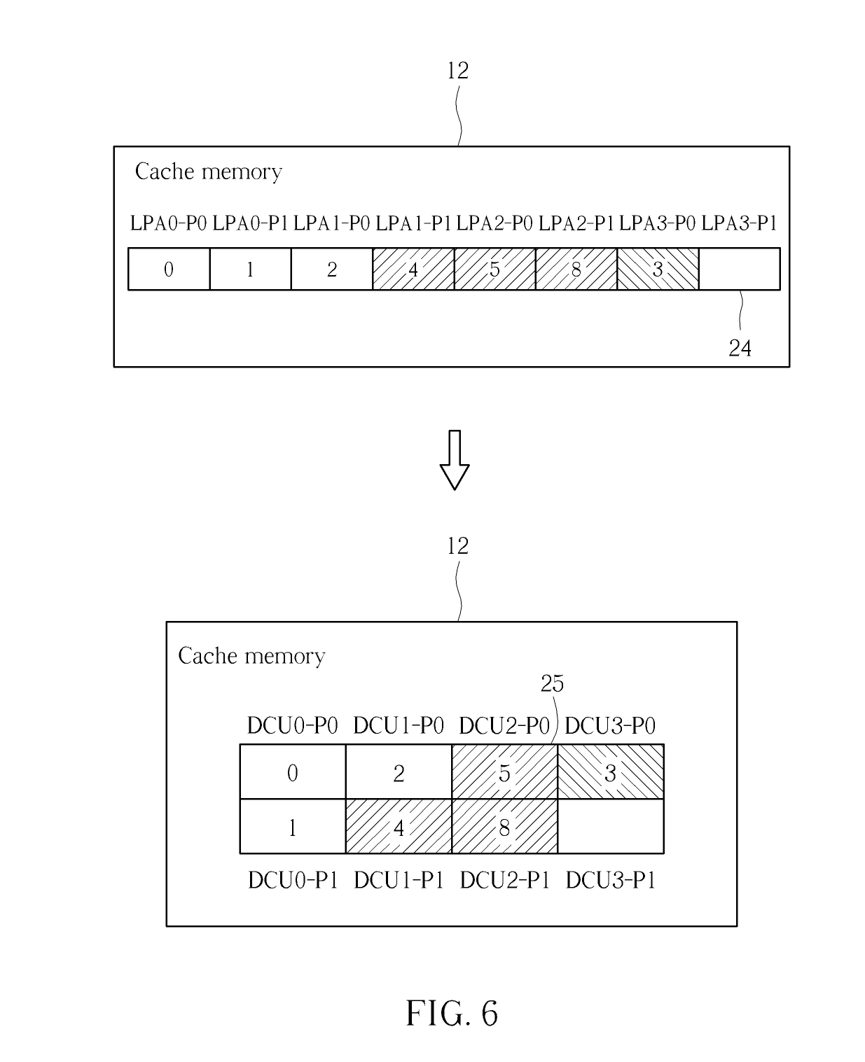

FIG. 6 illustrates a diagram of writing data into the solid state drive 10 according an embodiment of the present invention. According to the embodiment, when writing the data in the solid state drive 10, the solid state drive 10 may receive data transmitted by the host. The data may be converted to logical pages 0, 1, and 2. The logical pages 0, 1, and 2 may each have a logical allocation address and a logical allocation data. For logical page 0, the first connection table 24 may be searched for a logical allocation address of another logical page same as the logical page 0. Since there is no data temporarily stored in the first connection table 24, no another logical page same as the logical page 0 is found. It may then be determined if the logical plane address fields of the first connection table 24 is filled. If the logical plane address field LPA0-P0 is determined to be empty, the logical allocation address of the logical page 0 may be temporarily stored in the logical plane address field LPA0-P0 of the first connection table 24 and the logical allocation data of the logical page 0 may be temporarily stored in the data cache field DCU0-P0 of the data cache unit 25 corresponding to the logical plane address field LPA0-P0 to wait to be written to the lower memory level PO of the first flash memory FLASH0. Afterwards, it may be determined if at least one of the logical plane address fields of each of the logical plane addresses is filled. Since there is no data temporarily stored in the logical plane addresses LPA1 to LPA3, the temporarily stored logical page 0 may not yet be written in the first flash memory FLASH0.

The logical page 1 may be processed next. The same as logical page 0, no another logical page that may be the same as the logical page 1 is found in the first connection table 24. It may be determined if the logical plane address fields of the first connection table 24 is filled. The logical plane address field LPA0-P0 may already be filled by the logical page 0 and the logical plane address field LPA0-P1 may not yet be filled. The logical allocation address of the logical page 1 may then be temporarily stored in the logical plane address field LPA0-P1 of the first connection table 24 and the logical allocation data of the logical page 1 may be temporarily stored in the data cache field DCU0-P1 of the data cache unit 25 corresponding to the logical plane address field LPA0-P1 to wait to be written to the upper memory level P1 of the first flash memory FLASH0. It may be determined if at least one of the logical plane address fields of each of the logical plane addresses is filled. Since there is no data temporarily stored in the logical plane addresses LPA1 to LPA3, the temporarily stored logical page 0, and logical page 1 may not yet be written in the first flash memory FLASH0. The logical page 2 may be processed next. The same as logical page 0 and logical page 1, no another logical page that may be the same as the logical page 2 is found in the first connection table 24. It may then be determined if the logical plane address fields of the first connection table 24 is filled. The logical plane address field LPA0-P0 may already be filled by the logical page 0, the logical plane address field LPA0-P1 may already be filled by the logical page 1, and the next logical plane address field LPA1-P0 may not yet be filled. The logical allocation address of the logical page 2 may then be temporarily stored in the logical plane address field LPA1-P0 of the first connection table 24 and the logical allocation data of the logical page 2 may be temporarily stored in the data cache field DCU1-P0 of the data cache unit 25 corresponding to the logical plane address field LPA1-P0 to wait to be written to the lower memory level PO of the second flash memory FLASH1. It may be determined if at least one of the logical plane address fields of each of the logical plane addresses is filled. Since there is no data temporarily stored in the logical plane addresses LPA2 to LPA3, the temporarily stored logical pages 0, 1, and 2 may not yet be written in corresponding flash memories. The temporarily stored logical page may continue to accumulate.

The solid state drive 10 may continue to receive data and convert the data to logical pages 4, 5, and 8. According to the processing of the logical pages 4, 5, and 8, no same logical page with the logical pages 4, 5, and 8 is found in the first connection table 24. It may be determined if the logical plane address fields of the first connection table 24 is filled. As shown in shaded fields of FIG. 6, the logical allocation address of the logical pages 4, 5, and 8 may respectively then be temporarily stored in the logical plane address fields LPA1-P1, LPA2-P0, and LPA2-P1 of the first connection table 24 and the logical allocation data of the logical pages 4, 5, and 8 may respectively be temporarily stored in the data cache fields DCU1-P1, DCU2-P0, and DCU2-P1 of the data cache unit 25 respectively corresponding to the logical plane address fields LPA1-P1, LPA2-P0, and LPA2-P1 to wait to be written to the corresponding flash memories 20. Since there is no data temporarily stored in the logical plane address LPA3, the temporarily stored logical pages 0, 1, 2, 4, 5, and 8 may not yet be written in the corresponding flash memories.

The solid state drive 10 may continue to receive data and convert the data to logical pages 2 and 3. Upon searching, it may be determined that the logical plane address field LPA0-P1 of the first connection table 24 may have the same data as the logical page 2 and no another logical page the same as the logical pages 3 may be found in the first connection table 24. The subsequent logical page 2 received may be merged with the logical allocation data of the logical page 2 already temporarily stored in the data cache field DCU1-P0 of the data cache unit 25. As shown in another shaded fields of FIG. 6, the logical plane address field LPA3-P0 of the first connection table 24 may not be filled. The logical allocation address of the logical page 3 may then be temporarily stored in the logical plane address field LPA3-P0 of the first connection table 24 and the logical allocation data of the logical page 3 may be temporarily stored in the data cache field DCU3-P0 of the data cache unit 25 corresponding to the logical plane address field LPA3-P0. It may be determined if at least one of the logical plane address fields of each of the logical plane addresses is filled. Since at least one of the logical plane address fields of each of the logical plane addresses is filled, the logical pages 0, 1, 2, and 3 temporarily stored in the cache memory 12 may be simultaneously written in corresponding flash memories 20. Thus, the effect of reading of data may be reduced.

Although the above embodiment discloses that it may be determined if at least one of the logical plane address fields of each of the logical plane addresses may be filled before the logical pages corresponding the logical plane addresses may be written into corresponding flash memories, but the present invention is not limited to the embodiment presented above. The condition for writing the logical pages into corresponding flash memories may be set according to the need of the application. For example, it may be set that when the logical plane address fields of the first connection table is completely filled, the logical pages temporarily stored in the cache memory may simultaneously be written in corresponding flash memories.

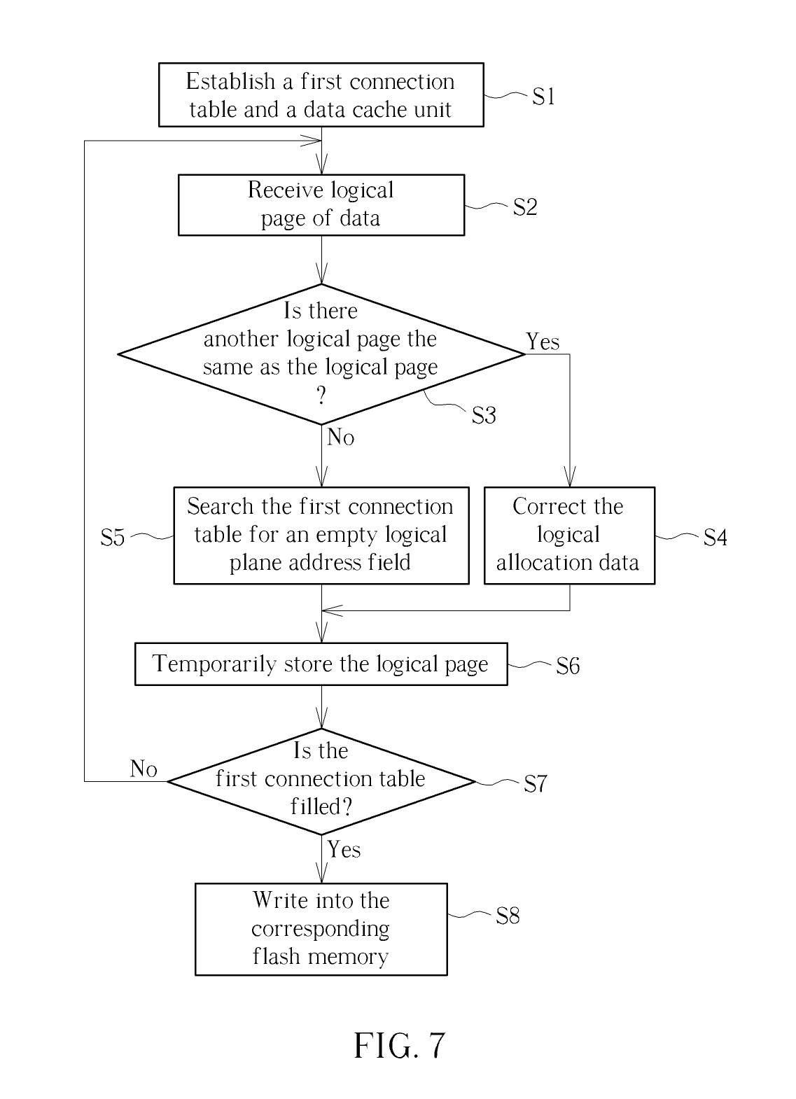

FIG. 7 illustrates a flowchart of a method of writing data in a solid state drive according to an embodiment of the present invention. The method of writing data in the solid state drive may include but is not limited to the following steps:

Step S1: a first connection table and a data cache unit may be established in the cache memory of the solid state drive; the first connection table may be set to have a logical plane address to temporarily store a logical allocation address of a logical page; the data cache unit may be set to have data cache field to temporarily store logical address data of the logical page;

Step S2: the solid state drive receives data from the host and converts the data into logical pages; a logical page may be in a data format having a logical allocation address and a logical allocation data;

Step S3: the first connection table may be searched for another logical page the same as the logical page; when the first connection table is found to have another logical page the same as the logical page, go to step S4; when the first connection table is found to not have another logical page the same as the logical page, go to step S5;

Step S4: the logical page received may be merged with the logical allocation data of the another logical page already temporarily stored in the data cache unit; go to step S6;

Step S5: the first connection table may be searched for an empty logical plane address field; go to step S6;

Step S6: the logical allocation address of the logical page may be temporarily stored in the empty logical plane address field of the first connection table and the logical allocation data of the logical page may be temporarily stored in a data cache field of the data cache unit corresponding to the empty logical plane address field;

Step S7: determine if the logical plane address fields of the first connection table is filled; when the first connection table is not filled, go to back to step S2 and continue receiving data from the host; when the first connection table is filled, go to step S8; and

Step S8: simultaneously write logical allocation addresses and a logical allocation data of the logical pages temporarily stored, respectively, in the first connection table and the data cache table of the data cache unit to the corresponding flash memories.

According to the method described above, the method of writing data in the solid state drive of the present invention may establish a first connection table and a data cache unit corresponding to each of the memory levels of the flash memories in a cache memory of the solid state drive. The first connection table may be used to temporarily store the logical allocation addresses of the logical pages and the data cache unit may be used to temporarily store the logical allocation data of the logical pages. By searching the first connection table for another logical page the same as the logical page, the time for comparison of data and the writing of repeated data may be reduced and the speed of search may be increased. The data may be statically allocated to logical plane address fields of the first connection table and the first connection table may dynamically be searched for empty logical plane address fields when allocating data to corresponding flash memories to equally distribute the writing of logical pages into the flash memories and equalize the life span of the flash memories. Furthermore, the present invention may use the cache memory to establish a first connection table and a data cache unit to accumulate data of the temporarily stored logical pages and add the ability to search for same data. When the logical plane addresses have been filled, simultaneously writing each logical page registered in the logical plane addresses to a corresponding flash memory to increase the efficiency of writing data in the solid state drive.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of writing data in a solid state drive, comprising:
establishing a first connection table and a data cache unit in a cache memory of the solid state drive;
receiving data from a host and converting the data to a logical page having a logical allocation address and logical allocation data;
searching the first connection table for another logical page the same as the logical page;
merging the logical page with the another logical page;
temporarily storing the logical allocation address in the first connection table and temporarily storing the logical allocation data in the data cache unit;
determining if the first connection table is filled; and
writing the logical page temporarily stored in the cache memory to a corresponding flash memory.

2. The method of claim 1, wherein temporarily storing the logical allocation address in the first connection table is temporarily storing the logical allocation address in a logical plane address field of the first connection table, and temporarily storing the logical allocation data in the data cache unit is temporarily storing the logical allocation data in a data cache field of the data cache unit corresponding to the logical plane address field.

3. The method of claim 2, wherein the first connection table is used to connect logical allocation addresses of logical pages temporarily stored in the cache memory to form a comparison table.

4. The method of claim 3, wherein sequence of the logical plane address fields is set according to flash memories of the solid state drive and memory levels of the flash memories.

5. The method of claim 2, wherein each flash memory of the solid state drive has a corresponding logical plane address, each logical plane address has a corresponding logical plane address field set according to a memory level of a corresponding flash memory.

6. The method of claim 2, wherein searching the first connection table for the another logical page the same as the logical page is searching logical plane address fields of the first connection table for a logical allocation address of the another logical page the same as the logical page.

7. The method of claim 6, further comprising:
when the first connection table does not have the another logical page same as the logical page, searching the first connection table for an empty logical plane address field;
temporarily storing the logical allocation address of the logical page in the empty logical plane address field of the first connection table; and
temporarily storing the logical allocation data of the logical page in a data cache field of the data cache unit corresponding to the empty logical plane address field.

8. The method of claim 2, wherein determining if the first connection table is filled is determining if at least one logical plane address field of each of logical plane addresses of the first connection table is filled, and writing the logical page temporarily stored in the cache memory to the corresponding flash memory is simultaneously writing logical pages temporarily stored in the cache memory to the corresponding flash memories.

9. The method of claim 2, wherein determining if the first connection table is filled is determining if at least one logical plane address field of each of logical plane addresses of the first connection table is filled, and writing the logical page temporarily stored in the cache memory to the corresponding flash memory is simultaneously writing each logical page registered in the logical plane addresses to the corresponding flash memory.

10. The method of claim 1, further comprising:
when the first connection table is not filled, continue receiving data from a host.

11. The method of claim 1, wherein writing the logical page temporarily stored in the cache memory to the corresponding flash memory is simultaneously writing the logical allocation address and the logical allocation data of the logical page temporarily stored respectively in first connection table and the data cache unit to the corresponding flash memory.
